(19) United States
(12) Patent Application Publication
(10) Pub. No.: US 2015/0161612 A1
(43) Pub. Date: Jun. 11, 2015

(54) METHOD AND SYSTEM FOR NETWORK BASED DYNAMIC CVC AUTHENTICATION

(71) Applicant: MasterCard International Incorporated, Purchase, NY (US)

(72) Inventors: Stephen Parento, White Plains, NY (US); Chris Jacklin, Peterborough (UK); Raj Kiran Karkara, Salt Lake City, UT (US)

(73) Assignee: MasterCard International Incorporated, Purchase, NY (US)

(21) Appl. No.: 14/098,066

(22) Filed: Dec. 5, 2013

(51) Int. Cl. G06Q 20/40; G06Q 20/34

(52) U.S. Cl. CPC G06Q 20/4018; G06Q 20/34

(57) ABSTRACT

Methods and systems for receiving an authorization request associated with a transaction, the authorization request including a payment account number and a card verification value; determining the authorization request is to be processed as having a dynamic card verification value; automatically bypassing, in response to the determination that the authorization request is to be processed as having a dynamic card verification value, at least one card verification process to be used in a processing of the authorization request; and sending the authorization request to a card verifier to verify the card verification value matches a dynamic card verification value of record. Some methods and systems include transmitting the authorization request to a payment network for authorization of the transaction; receiving an authorization response in reply to the transmitted authorization request; and providing an indication of the authorization response to a merchant associated with the transaction.

### BACKGROUND

Traditionally, a major concern of merchants and issuers of payment cards (such as credit or debit cards) in a transaction where the cardholder is not physically present with the payment card at the time a payment or purchase is being made is whether the person attempting to use the card is in fact an authorized cardholder or user of the card. These “card not present” (CNP) transactions may include Internet or on-line purchases, telephone, fax, and mail order transactions, purchases made via merchant applications on an electronic device, and other e-commerce transactions. When a cardholder is not present, it is difficult for the merchant to verify that the actual cardholder is indeed authorizing a purchase.

In an effort to reduce the incidence of credit card fraud in CNP transactions, a number of systems have been used to verify that the person using the card is authorized to use the card. One system is a card security code (CSC) system that typically assigns a 3-digit card verification value (CVC) number to a payment account number. The CSC's 3-digit value may be referred to by a variety of terms, however herein the term CVC will be understood to include all such terms. The CVC is separate and distinct from the payment card's payment account number (typically, 16 digits) and a PIN associated with the payment card, and is typically printed on the reverse face of the payment card. Relying on the CSC system, a merchant may require a person in a CNP transaction to provide the CVC associated with the payment card. Failing to provide the proper CVC, the merchant will deny the purchase or payment transaction.

Merchants and/or third party servicers may also mitigate the risk of CNP transactions by verifying the shipping address for a CNP transaction. The merchant may deny the CNP transaction in an instance the shipping address provided with the payment or purchase transaction does not match an address on record with the merchant or verifiable as being associated with the payment card.

However, the static CVC printed on the back of a payment card may be stolen or otherwise unscrupulously obtained along with the payment card's account number. Also, address verification and services providing such have limitations, including not being very effective at verifying foreign addresses that do not adhere to address format configurations similar to domestic addresses.

Therefore, it would be desirable to provide improved methods and apparatus for efficiently facilitating and processing payment card transactions with a dynamic CVC.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, wherein:

FIG. 1 is a flow diagram of an process, according to some embodiments herein;

FIG. 2 is an illustrative depiction of a display card, according to some embodiments herein;

FIG. 3 is a block diagram of a display card, in accordance with some embodiments herein;

FIG. 4 is a block diagram of a mobile device, in accordance with some embodiments herein;

FIG. 5 is an illustrative depiction of a system, according to one embodiment herein;

FIG. 6 is a flow diagram of an process, according to some embodiments herein;

FIG. 7 is a flow diagram of an process, according to some embodiments herein; and

FIG. 8 is schematic block diagram of an apparatus, according to some embodiments herein.

### DETAILED DESCRIPTION

In general, and for the purpose of introducing concepts of embodiments of the present disclosure, a payment device refers to, in general, a payment device of any embodiment (e.g., card, mobile telephone, a key fob, etc.) associated with a payment account number (PAN) that may be used in a payment or purchase transaction. As used herein, the terms purchase transaction and payment transaction or simply transaction may be used interchangeably unless stated otherwise. In general, the purchase transactions herein refer to CNP or e-commerce transaction. As such, these transactions may be requested by a merchant or other entity to have the cardholder or user presenting the payment device for payment verified as an authorized user of the payment device since, for example, a merchant cannot physically verify the user is even in possession of the payment device.

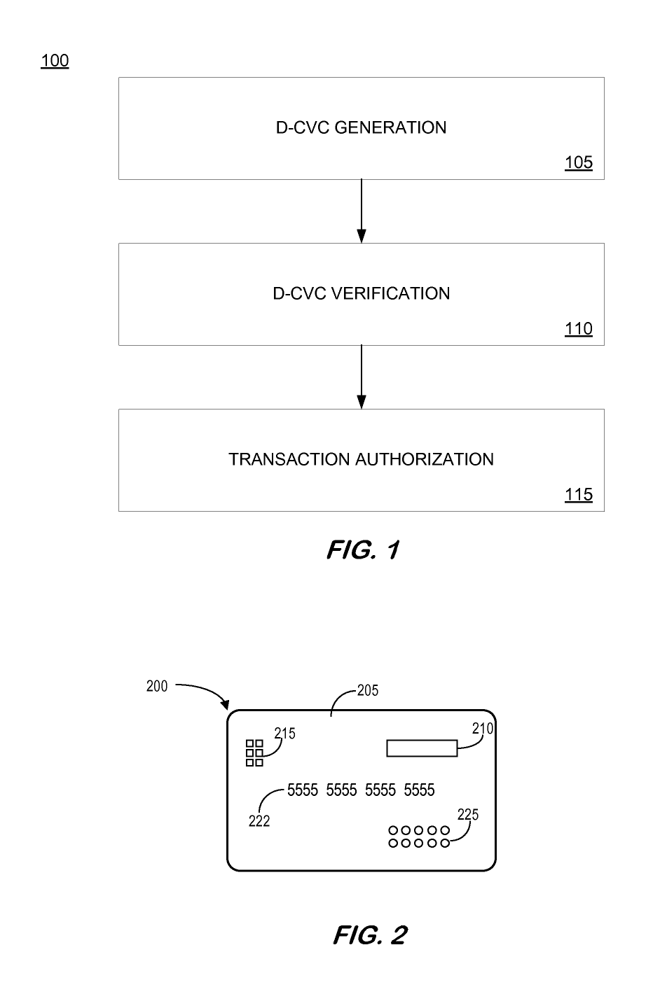

FIG. 1 is an illustrative diagram of a process 100 that may be utilized for supporting a dynamic card verification code (D-CVC) that facilitates processing of e-commerce payment card transactions. Process 100 includes an operation 105 to generate a D-CVC that will be assigned to, linked to, or otherwise associated with a particular payment device. A record of the D-CVC generated at operation 105 and the basis for the generation thereof is saved for future reference in the processing of transactions that will use the particular payment device. The D-CVC generated at operation 105 and the basis for the generation thereof may be saved by a card verifier entity, including a payment network service, and a 3^{rd} party card verifier service(er).

In some embodiments, a payment device may be a payment card having a display for displaying the D-CVC, referred to herein as a display card. The display of the display card may operate to communicate a card verification value, a D-CVC, that changes at least periodically (i.e., dynamic) to the user of the payment device (i.e., the cardholder). In some embodiments, the payment device may be, for example, an application executing on a mobile or other electronic device belonging to the cardholder. The mobile or other electronic device may generate a D-CVC as needed at the cardholder's request. Further details and aspects of how the D-CVC may be generated at operation 105 will be described in greater detail hereinbelow.

Referring to FIG. 1, process 100 proceeds to operation 110 where the D-CVC generated at operation 105 is available for use in association with a transaction. The D-CVC generated at operation 105 may be transmitted or communicated to a payment device owner (e.g., cardholder or user) subsequent to the generation of the D-CVC at operation 105. A user in possession of the payment device and the D-CVC generated at operation 105 may typically submit payment information of the payment device to a merchant for use in association with a transaction, where the payment information may include a payment account number (PAN) and the D-CVC generated at operation 105. In some aspects, the merchant may request other information related to the user and/or the payment device such as, for example, a shipping address for delivery of the goods and/or services being purchased in the transaction. The payment information is gathered by the merchant, in part, to request an authorization from an issuer of the payment device regarding the transaction. However, prior to authorizing the transaction to determine whether the transaction is either approved or denied regarding the availability of funds to source the transaction, process 100 verifies whether the D-CVC presented in association with the PAN with the transaction is the correct D-CVC at operation 110. That is, operation 110 verifies whether the D-CVC presented in association with the PAN with the transaction is the expected D-CVC, as reported by, for example, a card verifier entity. If the D-CVC presented by the user is a match with the D-CVC of record with the card verifier entity, then the transaction may be further processed and routed for authorization as indicated at operation 115. In the event the D-CVC presented by the user is not a match with the D-CVC of record as reported or maintained by the card verifier entity, then the transaction may be terminated with the merchant denying the transaction based on a card verification failure. In some aspects, the verification of the D-CVC at operation 110 may be performed before or at least contemporaneously with the transaction authorization of operation 115.

As used herein, the phrase “display card” might refer to, for example, a payment card, a credit card, a debit card, a loyalty program card, a badge, a license, a passport card, a radio frequency apparatus, and/or a contactless card. By way of example, FIG. 2 is an illustrative frontal view of a display card 200 payment device having a having a substantially planar display 210 affixed to a card-shaped body 205, according to some embodiments of the present disclosure. In particular, illustrated is a substantially card-shaped body 205 that may comprise an International Standards Organization/International Electrotechnical Commission (“ISO/IEC”) 7810 ID-1 sized card having a thickness of 0.76 mm (0.030 in) and a top area of 85.60×53.98 mm (3.370×2.125 in) with rounded corners having a radius of 2.88-3.48 mm. However, this size and shape are provided for illustrative purposes only. Those skilled in the art, upon reading the present disclosure, will appreciate that other shapes, form factors, sizes, and configurations of card-shaped or other shaped bodies may be used in conjunction with embodiments of the present disclosure.

Display 210 may be formed integral with the card body 205. Moreover, card body 205 and/or display 210 may be formed of one or more sheets of plastic or other materials. Display 210 may comprise, for example, a digital display including Light Emitting Diodes (“LEDs”), a thin film display, AMOLED, OLED, or the like. In some embodiments, display 210 may be a simplified display allowing display of no more than a fixed set number of alphanumeric data (e.g., such as three to six numbers or characters). In some embodiments, the display may allow the display of one or more characters, icons or the like. According to some other embodiments, display 210 is not integral with card body 205 but instead is affixed to card body 205 (e.g., via an adhesive). Card body 210 and display 210 might be formed of different materials. It is noted that any of the embodiments described herein may be formed of other materials having appropriate properties compatible with this disclosure, such as strength, luminosity, and/or flexibility.

According to some embodiments, display card 200 further includes one or more processors, coupled to or encapsulated in the card body 205, executing an operating system. Display 210 may be coupled to the card body and in communication with one or more of the processor(s) to provide visual information to a cardholder. Display card 210 may further include one or more storage unit(s) such as a memory device, coupled to or encapsulated in the card-shaped body and in communication with the processor(s), to store computer executable program code or instructions and data. The data may include, for example, one or more payment applications and display drivers or terminal emulators. Moreover execution of the operating system by the one or more processors may result in selection of one or more items of data or other information to be presented on the display 210. In some aspects, the selection of one or more items of data or other information to be presented on the display 210 may require an action by a user of the display card, while some other display card embodiments may not require, under at least some circumstances, an action by a user of the display card.

According to some embodiments, one or more input devices 225 may be used to enter user inputs, data, or to select among applications or modes of operation. In some embodiments, input devices 225 may include a number of keys or buttons. For example, in some embodiments, a plurality of keys or buttons may be provided, each corresponding to an alphanumeric value or an input selection. In other embodiments, a single button or key may be provided to activate or deactivate a function or application. In other embodiments, multiple buttons or keys may be provided, each corresponding to one or more applications, commands or functions.

In some embodiments, display card 200 may have multiple modes of communication. For example, a set of contacts 215 may be provided to allow contact communication with a terminal or other reader device.

In some embodiments, display card 200 may have a wireless or contact communication interface, allowing remote or contactless communication between the display card 200 and a terminal or other reader device. Display card 200 having an ability to perform such contactless communication is provided with an antenna (not shown) for conducting contactless communication using, for example, radio frequency (“RF”) electromagnetic waves. An oscillator (or oscillators) and additional circuitry (not shown) for one or more of modulation, demodulation, down-conversion and the like may further be provided. Pursuant to some embodiments, display card 200 has both contact and contactless modes of operation as will be described further herein.

In some embodiments, display card 200 may be configured as a dual-interface device having both contact and contactless modes of operation. Pursuant to some embodiments, the contact and contactless modes of operation may be performed in accordance with at least some aspects of one or more standards, such as those set forth in ISO/IEC 7816 and ISO/IEC 14443 or the like. Further, display card 200 may be configured to operate, at least in part, in accordance with one or more payment application standards such as the EMV standards promulgated by EMVCo, LLC. However, those skilled in the art, upon reading the present disclosure, will appreciate that other payment and transaction processed and standards may be used in conjunction with features herein. For the purposes of describing and illustrating features of some embodiments, display card 200 will be described herein as being compliant with the EMV standards. The EMV standards define the interaction at the physical, electrical, data and application levels between IC cards and IC card processing devices for financial transactions.

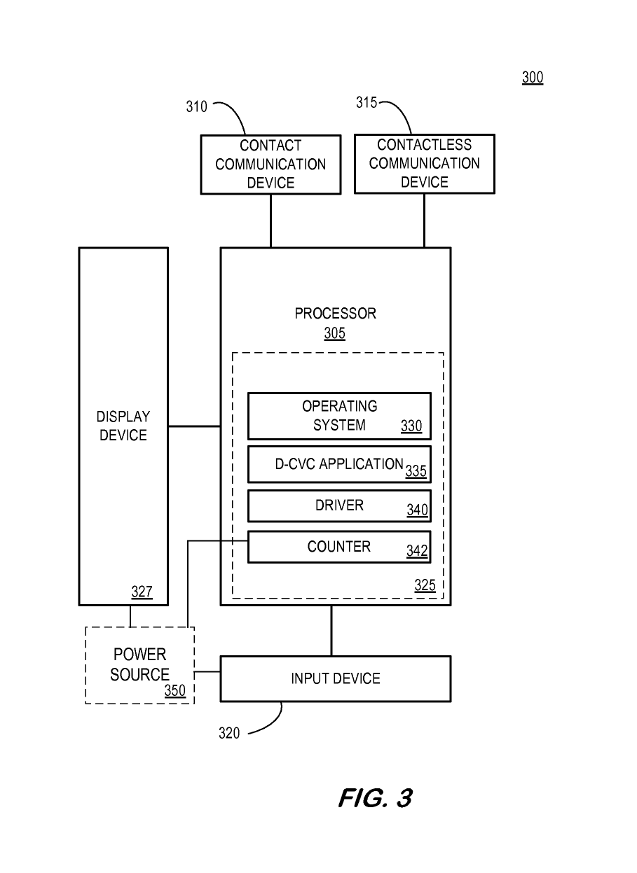

The embodiments described herein may be implemented using any number of different hardware configurations. For example, FIG. 3 illustrates a display card 300 that may, for example, be associated with processes herein, including but not limited to process 100 of FIG. 1. Display card 300 comprises a processor 305, such as one or more commercially available Central Processing Units (CPUs) in the form of one-chip microprocessors, coupled to a contact communication device 310 and/or a contactless communication device 315 allowing communication between the processor 305 and a contact or contactless reader or terminal (not shown in FIG. 3) that may further be in communication with a payment network (not shown in FIG. 3) to allow enhanced display and transaction processing using payment network support as will be further described herein. For example, contact communication device 310 may include circuitry and components allowing display card 300 to communicate with a terminal or reader device using contact communications technologies (e.g., pursuant to ISO/IEC 7816 or the like). Similarly, the contactless communication device 315 may include circuitry and components allowing the display card 300 to communicate with a terminal or reader device using contactless communications technologies (e.g., pursuant to ISO/IEC 14443 or the like). The communication devices 310, 315 may be used to communicate, for example, with one or more remote devices (not shown in FIG. 2). Display card 300 further includes an input device 320 (e.g., one or more switches or keys) and a display device 327.

Processor 305 also communicates with a storage unit 325. Storage unit 325 may comprise any appropriate information storage unit, including combinations of persistent or non-persistent storage units such as semiconductor memory devices. Storage unit 325 stores a program and/or instructions associated with an operating system for controlling processor 305 as well as one or more D-CVC generation applications 335 and display drivers 340. Processor 305 performs instructions of the programs 330, 335, and 340 and operates in accordance with any of the embodiments described herein. In some embodiments, processor 305 includes one or more secure elements that are personalized or configured to allow processor 305 to function as a payment chip pursuant to a standard such as the EMV standard.

While a single processor 305 is shown in FIG. 3, in some embodiments, two or more processors may be provided on display card 300. For example, one processor may be provided to perform standard payment chip processing, while a second processor may be provided to control the driver 340 as well as to interface with input device 320 and display device 327. In such embodiments, the second processor may interact with the first processor using an interface or communications bus (not shown). In some embodiments, the second processor (operating in conjunction with driver 340, input device 320, and display device 327) functions to allow display card 300 of the present disclosure to display a D-CVC generated by the display card to a user via display 327.

In some embodiments, processor 305 may perform instructions allowing the display card 300 to perform one or more functions using display device 327 and/or input device 320 using data received from a user, a service, terminal or reader device (received through the contact communication device 310 and/or contactless communication device 315). For example, display card 300 may display a D-CVC generated by the display card. The user may view the generated D-CVC in display 327 and provide the displayed D-CVC to a merchant for use during a transaction.

Pursuant to some embodiments, display card 300 also may include a battery or other power source 350 allowing display driver 340, display 327, and other elements to be operable even when display card 300 requires power for operation and is not connected to a terminal, reader device, or other power source. In some embodiments, to reduce power consumption, most of the information to be displayed on display 327 may be stored in display driver 340 so that the display device (or a payment chip thereof) need not be powered up each time information is needed.

The programs described herein may be stored in a compressed, uncompiled and/or encrypted format. The programs may furthermore include other program elements, such as an operating system, a database management system, and/or device drivers used by processor 305 to interface with peripheral devices. Storage unit 325 may include different types of memory, such as volatile and non-volatile memory and read-only and programmable memory. Storage unit 325 may store transaction card data such as, for example, a user's PAN. Storage unit 325 may store the operating system of display card 300. The operating system may load and execute program instructions or code and applications and provide file management or other basic card services to the applications. In some embodiments, one or more applications may reside directly on hardware, that is, may be outside the domain of the operating system. Preferably, the operating system may be stored in read-only memory (“ROM”) within storage unit 325. In an alternate embodiment, flash memory or other non-volatile and/or volatile types of memory may also be used in the storage unit 325. In addition to the basic services provided by the operating system, storage unit 325 may also include one or more D-CVC generation services or applications, as described herein.

As used herein, information may be “received” by or “transmitted” to, for example: (i) the display card 300 from another device; or (ii) a software application or module within display card 300 from another software application, module, or any other source.

In some embodiments, a display card in accordance with some embodiments herein may be used to or facilitate the generation of a D-CVC as described in conjunction with FIG. 1, operation 105. In some aspects, the D-CVC generated and associated with a particular payment device is known by a card verifier entity. The card verifier entity may be a card verifier service, an issuer or issuer servicer, a payment network service or servicer, a computer-implemented server, an Internet or browser based service, a software as a service (“SaaS”) or other implementations that function, at least in part, to verify a D-CVC. The D-CVC generated and associated with a particular payment device is provided to a merchant during a transaction (as discussed above) and is verified with a D-CVC known (i.e., “of record”) by the card verifier entity. The card verifier entity “expects” the D-CVC of record to also be included in the transaction data from a merchant in order to verify the received D-CVC as valid. Otherwise, the card verifier entity will reject the transaction as not being “verified”. Accordingly, the D-CVC generated by, for example, the display card needs to be synchronized (i.e., synced) in order to verify the D-CVC submitted in association with a transaction and a particular payment device is, in fact, the D-CVC expected for that particular payment device at the particular time the transaction is being processed since the D-CVCs herein change over time.

Regarding a display card such as, for example, display card 200 and 300 herein, a counter 345 of the display card may be synced to a card verifier entity (e.g., a D-CVC verification server) during a manufacturing process of the display card. In some embodiments, the display card may be synced to a card verifier entity during a “personalization” process of the display card, notwithstanding whether or not the personalization process is viewed as comprising the manufacture of the display card. The counter 345 of display card 300 may be synced to a card verifier entity to enable the card verifier entity to validate or verify the D-CVC provided with a transaction during a D-CVC verification process (e.g., D-CVC verification of operation 110).

In some aspects, the syncing of the display card and the card verifier entity may occur in number of different manners. Examples include, but are not limited to, the following. In a first manner which is based on a date as the basis of the D-CVC generation, the display card's internal D-CVC token counter starts at a predetermined count. For example, the display card's counter 345 may start on day 1 with a checksum counter at position 1. Thereafter, as the date progresses the checksum counter of the display card changes based on a preconfigured relationship, logic, or algorithm. As an example, on day 1 the checksum is counter 1, on day 2 the checksum is counter 3, and so on. In some aspects, the internal power source 350 of the display card enables the display card to continually maintain an accurate accounting of the date.

In some other embodiments, the syncing of the display card and the card verifier entity may be based on a date and a time. In this example, the display card's internal CVC token counter may start at hour 0 on day 1 with the checksum counter of the display at position 1. Furthermore, as date and time progresses through the life of the display card, the checksum counter will change based on a predetermined and known relationship, logic, or algorithm. For example, on day 1, hour 0 the checksum is counter 1; day 1, hour 3 the checksum is counter 3, and so on.

It is noted and will be understood that other methods, relationships, logic, or algorithms may be used in conjunction with (initially) syncing a display card (or other device) with a card verifier entity so that the card verifier entity may “know” the D-CVC that should be associated with a particular payment device.

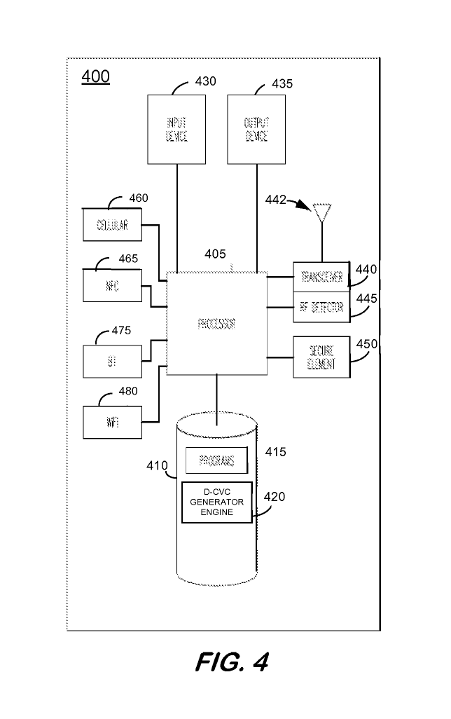

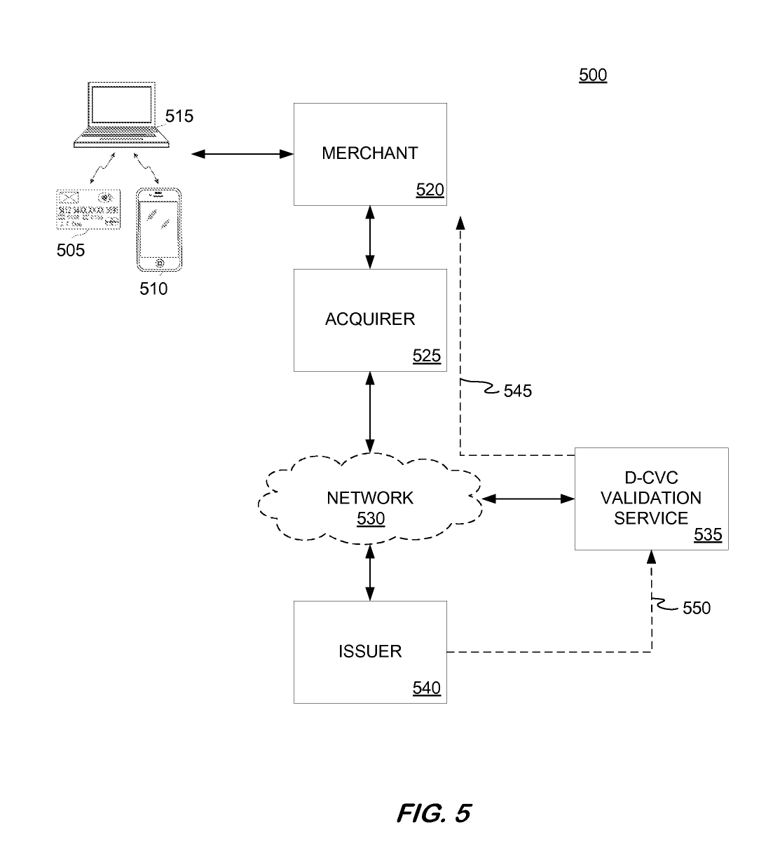

In some aspects herein, embodiments of a payment device may be embodied in an application, “app”, program, a browser (or browser-enabled application, extension, or add-on), computer-readable instructions and the like executing on a mobile device, and a device having a processor to execute an application or program instructions. In some aspects, such devices may be said to be encompassed by disclosures herein referring to a “mobile device”, even where such an electronic device may not necessarily be easily transported (e.g., a desktop PC). In some aspects, the mobile device may be a device including telephony functionality and implemented as any number of different hardware, software, and combination thereof configurations. For example, FIG. 4 is a block diagram of an apparatus, device, or system for a multifunctional mobile device 400 including a mobile or cellular telephone capability and a short-range wireless communication capability. FIG. 4 does not imply or necessarily represent a physical layout of mobile device 400. In its hardware and in some of its software/firmware, mobile device 400 may be substantially conventional. However, mobile device 400 may include hardware, software, firmware, and combinations thereof to implement and embody aspects of the present disclosure, including the methods and processes herein.

Mobile device 400 may include a conventional housing (not explicitly shown) that contains and/or supports the other components of the mobile telephone. The housing may, for example, be shaped and sized so as to be held in the user's hand. In some embodiments, device 400 may be housed in a device such as a tablet computing device and other form factors.

Mobile device 400 may include a processor 405 that processes and controls data in the mobile device that is interfaced with a memory 410 and capable of executing program instructions 415 stored in memory 410, a transceiver 440 for transmitting and receiving communication signals to and from antenna 442, and a RF detector 445 comprising part of the transceiver for detecting RF signals. Though not separately depicted in FIG. 4, memory 410 may include or encompass, in various embodiments, random access memory (RAM), read only memory (ROM), a SIM card, flash memory, and other types and forms of data storage devices and media. The processes disclosed herein may be implemented by the components of mobile device 400. For example, D-CVC generation engine 420 may be invoked to generate a D-CVC value under the control of processor 405 and programs 415 to effectuate the processes disclosed herein.

Transceiver 440 may be coupled to antenna 442 and connects to the communication channel(s) by which mobile telephone 400 communicates via a mobile network (not shown). The transceiver is in communication with antenna 442 that may serve to transmit and receive wireless wide-range and short-range communication signals. Mobile telephone 400 may also include an input device 430 (e.g., a keypad, keyboard, touchscreen system, voice input components, etc.) for receiving inputs from a user, and an output device 435 (e.g., a speaker, an indicator light, a display, etc.) for providing an output of the mobile telephone to the user or other entities.

In conventional fashion, transceiver 440 operates to transmit, via antenna 442, voice signals received from a user through input device 430, and operates to reproduce, via output device 435 (e.g., a speaker), voice signals received via antenna 442. Transceiver 440 may also further operate to handle transmission and reception of text messages and/or other data communications via antenna 442. In some embodiments, mobile telephone 400 may transmit wireless communication signals in any frequency range and power, including those now used and those that may be used in the future without limit.

Mobile telephone 400 may be capable of communicating with another device via cellular telephone signals as provided by a cellular component or module 460 and a variety of short-range communication protocols, such as and by NFC signals as provided by NFC module or components 465 or the like, Bluetooth® as provided by a Bluetooth® module 475, and by a wireless local area network (e.g., Wi-Fi, based on IEEE 802.11 b/g/n or other standards) as provided by a Wifi module 480.

In some embodiments, mobile telephone 400 may be a NFC-enabled mobile telephone equipped to operate as a secure proximity payment device and interact/communicate with another device (not shown in FIG. 4) such as a ticket kiosk/device and a contactless-POS terminal or other device that may include a radio frequency identification (“RFID”) tag. In some embodiments, the contactless-POS or other device and mobile telephone 400 may typically be positioned in close proximity of each other when communicating using NFC signals. In some aspects, the contactless-POS or other device and mobile telephone 400 may be within about 0-10 millimeters of each other in order for a RF power field generated by either the mobile telephone and the contactless-POS terminal or other device to transfer data therebetween.

In some embodiments, the methods and processes herein, including the functionality and operation of a mobile device or other wireless communication mobile device in accordance with the methods and processes herein related to a D-CVC may be included, supplied, or otherwise provisioned with the mobile telephone or other wireless communication mobile device to operate independently of any other features of the mobile telephone or other wireless communication mobile device. In some aspects, at least some aspects of the mobile device's functionality to operate as a payment device may be stored or located in secure element 450. The configuration of secure element 450 may be provided in conformance with one or more industry “standards”.

Regarding a device such as, for example, mobile device 400 herein, a user or cardholder may obtain an application or functionality for generating a D-CVC with the aid of the mobile device. In one embodiment, the cardholder may download a mobile “app” from an issuer, an “app” store or service compatible with the mobile device, or a third party to their mobile device. Once the mobile device is enabled to operate to generate a D-CVC, the cardholder may link or otherwise associate their PAN with the D-CVC app so that they can request a D-CVC code for use during an e-commerce shopping experience. The D-CVC value generated at the mobile device may be synced to a card verifier entity (e.g., a D-CVC validation server) as-needed (on request) with real time syncing between the mobile app and the card verifier entity. The syncing may occur over a number of communication channels, including one of the more communication channels compatible with the mobile device (e.g., mobile telephony network, messaging (e.g., MMS, SMS, etc.), WiFi, NFC, Bluetooth, etc.). In some aspects, the generation of the D-CVC generated by the mobile app may occur in number of different manners. Examples include, but are not limited to, those discussed hereinabove regarding the (1) the date basis and (2) the date and time basis. It will be understood that other methods, relationships, logic, or algorithms may be used in conjunction with a syncing a mobile device (or other device) with a card verifier entity so that the card verifier may “know” the D-CVC that should be associated with a particular payment device.

FIG. 5 is a block diagram illustrating a D-CVC enabled payment device and system 500 according to an embodiment herein. System 500 may be used to initiate and complete Internet-based, e-commerce, and other CNP transactions in accordance with processes described herein. In some aspects, display card 505 and a mobile app executing on mobile device 510 may generate a D-CVC in accordance with other aspects herein. In some aspects, the D-CVC generated by display card 505 and 510 may be entered into an e-commerce shopping cart presence of a merchant 520 presented in an internet browser on computing device 515 or via a contact or contactless card or device reader (not shown). Computing device 515, which may be a laptop computer, desktop computer, tablet computing device and the like, is connected (wirelessly and/or via cables, such as fiber-optic cable, WiFi, etc.) to merchant 520. A consumer cardholder or user may provide payment information to the merchant during a checkout at the merchant's e-commerce site. The payment information may include a PAN (or proxy thereof) and a card verification value (e.g., a D-CVC). In some embodiments, the D-CVC may be a 3-digit numeral that is similar in outward appearances to a conventional CVC. The D-CVC may be generated by display card 505 and 510 automatically (e.g., periodically) or upon request by the user.

The payment device comprising the display card 505 may be a portable digital device, such as a key fob and some other token. In some aspects, the mobile device 510 having a mobile app executing thereon may include a tablet computing device, a “phablet”, a multimedia player, a smartwatch, and the like.

Transaction details, including the payment information, are transmitted to a merchant 520. Merchant 520 receives the payment information including the PAN and the card verification value. Merchant 520 (or a merchant servicer) may operate to determine whether the card verification value received from the consumer in the transaction details is a D-CVC that should be processed in accordance with D-CVC processing methods herein. Accordingly, merchant 520 (or a merchant servicer) may include functionality to determine, based on a number of factors or processes, whether the card verification value is a D-CVC (as will be described in greater detail below).

In the event merchant 520 determines that the card verification value is a D-CVC, then merchant 520 may forward an authorization request including the received card verification value. In some aspects, merchant 520 may include an indicator in the authorization request that indicates that the authorization request is to be processed in accordance with a D-CVC type processing. That is, the authorization request from merchant 520 may include an indicator of some type (e.g., a specific value or “flag” in a specific field) in the authorization request itself or another message. In some embodiments, upon determining the authorization request is to be processed in accordance with a D-CVC type processing, merchant 520 may cause the authorization request to be processed by having the authorization routed to a particular payment network, service, and/or servicer.

Referring still to FIG. 5, the authorization request is sent from merchant 520 to acquirer 525. Again, the authorization request includes the card verification value received from the merchant. In some embodiments, the authorization request is routed to a card verifier such as, for example, D-CVC validation service 535 (i.e., a card verifier) via network 530. In some aspects, network 530 may be a payment network, where the payment network operator may, at least, route the authorization request to D-CVC validation service 535. In some embodiments, the payment network operator may also operate D-CVC validation service 535. In some other embodiments, network 530 may be a public network (e.g., the Internet), a private network, or a network other than a payment network. In either case, the authorization request is routed to D-CVC validation service 535.

D-CVC validation service 535 operates to validate or verify that the card verification value received in the authorization request matches the D-CVC “on record” and known by D-CVC validation service 535. The D-CVC of record may be the D-CVC generated and synced with the particular payment device used and identified in the payment information of the transaction details included in the authorization request. In some embodiments, the D-CVC of record is generated by D-CVC validation service 535. The D-CVC of record may be the D-CVC generated and synced with the particular payment device, whether the payment device is, for example, a display card (or other) device or a mobile application that generates its D-CVC on request. That is, the D-CVC of record is that D-CVC that is calculated, maintained, and currently expected to be associated with the particular payment device used in current payment transaction.

In the event that D-CVC validation service 535 verifies that the card verification value received in the authorization request matches the D-CVC of record, then the authorization request may be routed to issuer 540 via network 530 where the network may typically be a payment network. The authorization request may, post D-CVC verification by D-CVC validation service 535, be authorized, in many aspects, in accordance with a conventional transaction authorization. That is, issuer 540 may determine whether there are sufficient funds available to approve the transaction, whether the payment has been reported stolen or lost, whether the transaction appears fraudulent based on, for example, a suspicious or uncharacteristic transaction details for the cardholder, etc.

In the event that D-CVC validation service 535 cannot verify that the card verification value received in the authorization request matches the D-CVC of record (i.e., there is not a match), then the authorization request may be rejected without being routed to issuer 540. This rejection of the authorization request in depicted in FIG. 5 by the line 545 that represents a rejection of the authorization based on a failure to verify the card verification value received in the transaction details. Such a failure may be based on the card verification value received in the authorization request not matching the D-CVC of record; however other instances may trigger a failure to verify the card verification value received in the transaction details (e.g., a communications time-out, a corrupt or indecipherable authorization requests, and other factors). While line 545 that represents a rejection of the authorization based on a failure to verify the card verification value is shown going directly back to merchant 520, the communication of the failure may, in some embodiments, be routed via network 530 and acquirer 525 to merchant 520.

In some aspects herein, issuer 540 may communicate certain information to D-CVC validation service 535 that might be used by D-CVC validation service 535 to, for example, provide various aspects of verifying the card verification value received and processed by the D-CVC validation service. In one embodiment, issuer 540 may provide a “key” or other data that D-CVC validation service 535 may use to, for example, verify the which D-CVC value is associated with a particular PAN or other validation related processes. This provisioning of information to D-CVC validation service 535 is depicted in FIG. 5 by the line 550.

In some aspects herein, D-CVC validation service 535 operates to validate or verify that the card verification value received in an authorization request matches the D-CVC “on record” and known by D-CVC validation service 535. In some regards, the D-CVC validation process provided by the card verifier (e.g., D-CVC validation service 535) may, depending at least in part, on the type of device used to deliver the D-CVC.

Regarding a payment device such as, for example, a display card (e.g., display cards 200 and 300 of FIGS. 2 and 3) a validation process provided by D-CVC validation service 535 may initially start when a consumer user enters a 16-digit PAN number and a 3-digit D-CVC value presented on the display card during checkout at a merchant's website or app. The merchant may proceed to forward, at least, this information in an authorization request via an acquirer to the D-CVC validation service for authorization. Upon receiving the authorization request, the D-CVC validation service 535 may carry out the validation in the following manner. In the instance that the synchronization between the display card's D-CVC and the D-CVC validation service is date based (time and date based), the card verifier (e.g., a payment network operator and D-CVC validation service 535) may, upon receiving the transaction from the acquirer, use the PAN to determine whether the Bank Identification Number, BIN (or PAN) provided in the transaction is a D-CVC BIN (or PAN). In the event it is determined that the BIN (or PAN) is a D-CVC BIN (or PAN), the D-CVC value received in the authorization request message is examined to compare, based on the date (time and date), a checksum digit counter of the received D-CVC against a stored value of the CVC validation server. In some aspects, a checksum digit of the card verification value may be one of the three digit locations of a three-digit D-CVC. However, other or alternative checksum or other verification mechanisms may be used. Which digit is designated the checksum for a particular PAN having a D-CVC as disclosed herein may be determined at an initial syncing of the PAN's D-CVC and the D-CVC of the card verifier (e.g., the CVC validation server).

In some aspects, if the checksum counter value received in the authorization request matches the stored and expected value in the CVC validation server, the remaining two other digits of the D-CVC are verified against the stored value on the CVC validation server. The two other digits forming the D-CVC and received in addition to the checksum digit should be an exact match against the stored value on the CVC validation server.

In some aspects, embodiments for validating a D-CVC associated with a transaction herein may include a network velocity limit mechanism. The network velocity limit mechanism may operate to limit the processing of, for example, no more than three (or some other number) transaction attempts within a one minute span. The use of the network velocity limit mechanism may prevent brute force attacks that may attempt to thwart the card verification processes herein by submitting multiple D-CVCs in a very short period time until the expected D-CVC is submitted for validation.

In the instance the validation fails, such as when the checksum counter value received in the authorization request does not match the stored value from the D-CVC validation server, then the card verifier entity (e.g., the D-CVC validation server) may reject the transaction and send a message (e.g., an authorization response) indicating a “failed validation”. In contrast, upon a successful D-CVC validation, the authorization request is forwarded to the issuer with, in some aspects, an indicator indicating that the transaction is a “validated transaction”. Issuers, upon receiving the authorization request message from the card verification entity, may check for other transaction authorization criteria such as “available funds” or if a payment card associated with the PAN is blocked or reported stolen. The authorization request is either approved or denied by the issuer and an indication thereof is transmitted back to the merchant to complete the transaction authorization.

Regarding a mobile application that can generate a D-CVC as disclosed herein, a user may request the generation of a D-CVC when a consumer user desires a D-CVC for use in a purchase or payment transaction. Once the D-CVC request is made, the mobile app herein requests a card verification value or code from the D-CVC validation service 535 in real time. Further, the mobile app may cause the generated D-CVC to be displayed or presented to the consumer user for use in a transaction. During a checkout at a merchant's website or app, the consumer may typically enter their 16-digit PAN and the 3-digit D-CVC value requested via the mobile app and subsequently communicated to the user by the mobile app. The merchant receives the PAN and the D-CVC generated by the mobile app and forwards this information, at least, in an authorization request to the card verifier entity (e.g., D-CVC validation service 535) via an acquirer. Upon receiving the authorization request, validation may proceed in the following manner.

In an initial step, the card verifier entity (e.g., D-CVC validation service 535, 3^{rd}-party provider, payment network operator, etc.) receives the transaction and the transaction detailed information from the acquirer. Then, the PAN is used to determine whether a BIN (or PAN) is a D-CVC BIN (or PAN). If the BIN (or PAN) is a D-CVC BIN (or PAN), the three-digit CVC (card verification) value received in the authorization message is compared against the D-CVC value generated earlier by the D-CVC validation server. In some aspects, since the mobile app embodiment herein is a “smart terminal” (i.e., connected to cellular network, Wi-Fi, or other communication network), the D-CVC validation server (e.g., D-CVC validation service 535) can instantly confirm whether the 3-digit CVC value including the checksum counter received in the authorization request message matches the D-CVC number delivered to consumer via the mobile app. That is, there is no need to calculate the D-CVC by the D-CVC validation service 535 since the D-CVC included in the authorization was generated in response to a request for the D-CVC by the D-CVC validation service.

In the instance the validation fails, the card verifier entity (e.g., the D-CVC validation server) may reject the transaction and send a message (e.g., an authorization response) indicating a “failed validation” to the merchant. On the contrary, when the D-CVC received in the authorization request is validated, the authorization request is forwarded to the issuer with, in some aspects, an indicator indicating that the transaction is a “validated transaction”. Issuers, upon receiving the authorization request message from the card verification entity, may check for other transaction authorization criteria such as “available funds” or if a payment card associated with the Pan is blocked or reported stolen. The authorization request is either approved or denied by the issuer and an indication thereof is transmitted back to the merchant to complete the transaction authorization.

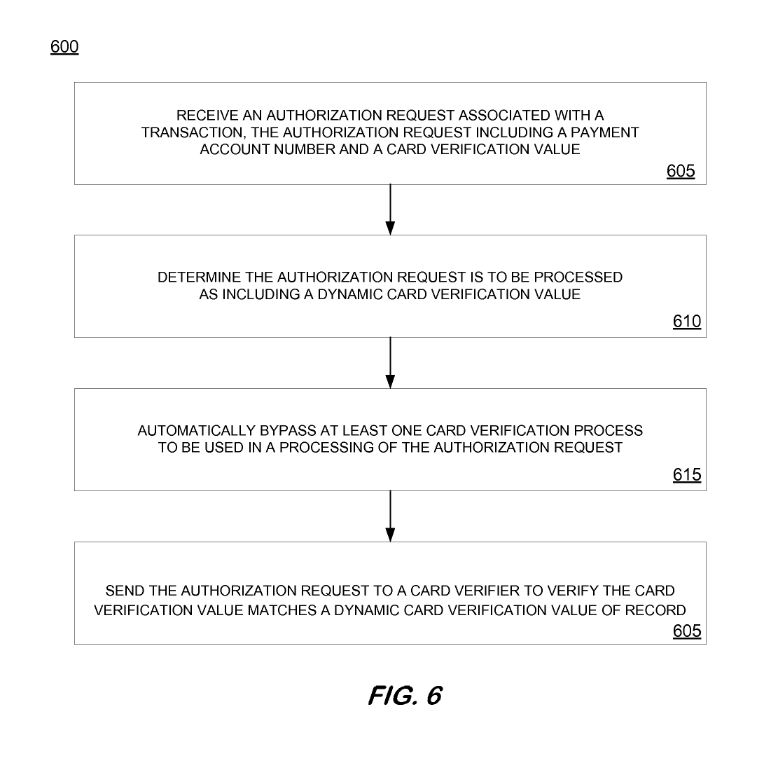

FIG. 6 is an illustrative depiction of a process 600 related to aspects of processing a transaction including a D-CVC, in accordance with some embodiments herein. At operation 605, an authorization request associated with a transaction is received by a merchant. As discussed at other points herein, the transaction may include a CNP transaction. Accordingly, the consumer cardholder user may be asked to provide their PAN as well a card verification value or (D-)CVC associated with the PAN. In accordance with some aspects herein, the card verification value may be obtained from or delivered by a display card, a mobile app, and other devices and systems. Other additional information may also be requested of and supplied by the user to the merchant. Payment information including, at least, the PAN and the card verification value, associated with a transaction may be used to form an authorization request by the merchant.

At operation 610, a determination is made to determine whether the authorization request is to be processed as including a D-CVC. That is, in the instance it is determined that the authorization request is to be processed as including a D-CVC then the authorization request will be processed as disclosed above regarding, for example, FIG. 5. Otherwise, the authorization request may be processed in a conventional manner. In accordance with some aspects herein, including process 600, the determination of whether a transaction includes a D-CVC may occur before the transaction is authorized.

Continuing with process 600, operation 615 may, in response to it being determined at operation 610 that the transaction is to be processed as a D-CVC transaction, automatically bypass or disable at least one card verification process. The at least one card verification process that might be disabled or bypassed at operation 615 in the processing of the transaction since it includes a D-CVC may be a process that would be invoked in the absence of the D-CVC. One such example may include an address verification service where such a check can be disabled or bypassed given the benefits provided by the D-CVC validation aspects applied to a D-CVC transaction herein.

Having previously determined that the transaction is to be processed as a D-CVC transaction, the authorization request may be sent to a card verifier such as, for example, a D-CVC validation service (535) at operation 620. In one or more further operations (not shown in FIG. 6) the card verifier may operate to determine whether the card verification value included in the authorization request and obtained from or delivered by a display card, a mobile app, and other devices and systems matches the D-CVC of the card verifier. In some instances, the card verifier may verify the card verification value included in the authorization request is as expected and matches the D-CVC of record with the card verifier. In other instances, the card verifier may determine the card verification value included in the authorization request is not as expected and fails to match the D-CVC of record with the card verifier. In such cases, the card verifier may generate a “failed validation” indicator and provide such in a message, authorization response, or reply to the merchant to notify the merchant the D-CVC was not verified as being accurate. In some aspects, the merchant and systems thereof are adapted to accept the “failed validation” indicator, where such an indicator may be configured to interface with merchant terminals and systems.

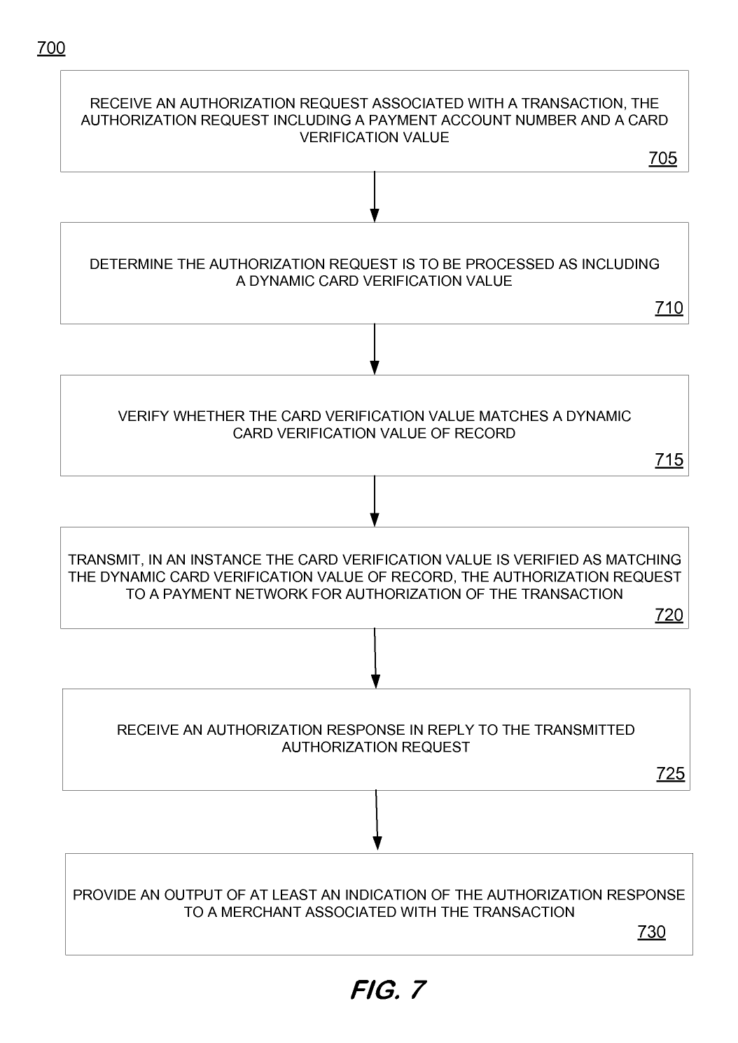

FIG. 7 is an illustrative depiction of a process 700 related to some aspects of processing a transaction including a D-CVC, in accordance with some embodiments herein. At operation 705, an authorization request associated with a transaction is received by a service provider such a card verifier. In some aspects, the service provider may be a payment network provider or operator. In other aspects, the transaction is a CNP transaction and the authorization request might include, as a minimum, a PAN and a card verification value may be included in the authorization request. In some instances, the authorization request may include a number of other detailed information, including for example a consumer user's name, address, and other bibliographic and identifying information, transaction details such as, for example, a merchant identifier, a description of items being purchased in the transaction, and any other information that may be used to process the authorization request. In some aspects, the card verification value may comprise a 3-digit numeric string that has, in some instances the outward appearance of a conventional CVC, including when the card verification value is actually D-CVC. IN accordance with the present disclosure, the card verification value may include a D-CVC generated and delivered by, for example, a display card and a mobile application.

The authorization request received at operation 705 may be acted upon or processed to determine whether the authorization request includes a D-CVC and should therefore be processed in accordance with rules and procedures for processing D-CVC transactions. In some aspects, the PAN may be analyzed to determine if the BIN associated with the PAN (or the PAN itself) is a D-CVC BIN (or PAN). The determination of operation 710 may be facilitated by a lookup table, a database query, and other mechanisms. In an instance operation 710 determines the authorization request does not include a D-CVC or otherwise should not be processed in accordance with procedures for the processing of D-CVC transactions, then the authorization request may be processed in a conventional manner.

In response to operation 710 determining that the authorization request includes a D-CVC and should be processed in accordance with procedures for the processing of D-CVC transactions, a verification is made at operation 715 to verify or otherwise ascertain whether the card verification value included in the authorization request and determined to be a D-CVC at operation 710 matches the D-CVC value that is associated with the PAN and is known (i.e., “of record”) by an entity controlling process 700 such as a card verifier system, service, server, or apparatus. In some aspects, the D-CVC value that is associated with the PAN is known because it has been synced (for example, during an initial configuration of a display card) with the device that generated the card verification value submitted with the transaction. Operation 715 may verify that the card verification value (e.g., a D-CVC) included in the transaction request does match the expected D-CVC on record with the card verifier entity.

At operation 720, the positive verification of operation 715 may invoke a transmitting of the authorization request to a payment network for authorization of the transaction. In this manner, it is seen that the card is verified (operations 705, 710, and 715) in some embodiments prior to the authorization request being forwarded to an issuer (operation 720) for transaction approval or rejection. The authorization request forwarded or sent to the issuer for authorization is processed at operations 725 and 730 to receive an authorization response in reply to the transmitted authorization request and provide an output of at least an indication of the authorization response to a merchant associated with the transaction, respectively.

In some aspects, the devices, systems, and methods disclosed herein may include and encompass, at least in part, card present transactions. In some embodiments, a merchant may receive a D-CVC directly from a D-CVC enabled device presented to a merchant at the merchant's location. In some aspects, the merchant's location may comprise a point of sale (POS) terminal. Referring to FIG. 5 that illustrates a block diagram including a D-CVC enabled payment device and system 500 according to an embodiment herein, system 500 may be used to initiate and complete card present transactions in accordance with at least some processes described herein. In some aspects, display card 505 may generate a D-CVC in accordance with other aspects herein. In some aspects, display card 505 may include, for example, a contact and/or a contactless communication device as described hereinabove with respect to, for example, FIG. 3.

The D-CVC generated by display card 505 may be provided to or otherwise obtained directly from the display card by merchant 520. In some embodiments, the merchant in this card present transaction example may obtain the D-CVC via a contact and/or contactless card reader (e.g., POS terminal) corresponding to and compatible with the functionality of the display card. Accordingly, computing device 515 may not be used or needed in a card present use-case since the D-CVC may be obtained directly from the display card 505 that is present at the merchant location.

In some embodiments, payment information including a PAN (or proxy thereof) and a card verification value (e.g., a D-CVC) may be obtained by the merchant from the display card 505. As noted above, the D-CVC may be a 3-digit numeral similar in outward appearances to a conventional CVC in some aspects. The D-CVC may be generated by display card 505 automatically (e.g., periodically) or upon request by the user. Transaction details, including the payment information, may be transmitted to or otherwise received or obtained by merchant 520, including the PAN and the card verification value. In accordance with other aspects herein, merchant 520 (or a merchant servicer) may operate to determine whether the card verification value received from the consumer in the transaction details is a D-CVC that should be processed in accordance with D-CVC processing methods herein. Accordingly, merchant 520 (or a merchant servicer) may include functionality to determine, based on a number of factors or processes, whether the card verification value is a D-CVC (as will be described in greater detail below).

In some aspects, a card present transaction involving a display card or other device that generates a D-CVC as disclosed herein may be processed in accordance with the various methods, processes, and transaction flows disclosed herein after the D-CVC is received by, communicated to, or otherwise obtained by the merchant. In some aspects, a card present transaction process flow may use a D-CVC generated as disclosed herein as, for example, a security feature that enhances, compliments, or replaces one or more other security features of a display card and/or a transaction processing method. For example, a display card that generates a D-CVC in accordance herewith may compliment or enhance the security features of a display card having a integrated (IC) chip (i.e., a “chip” card).

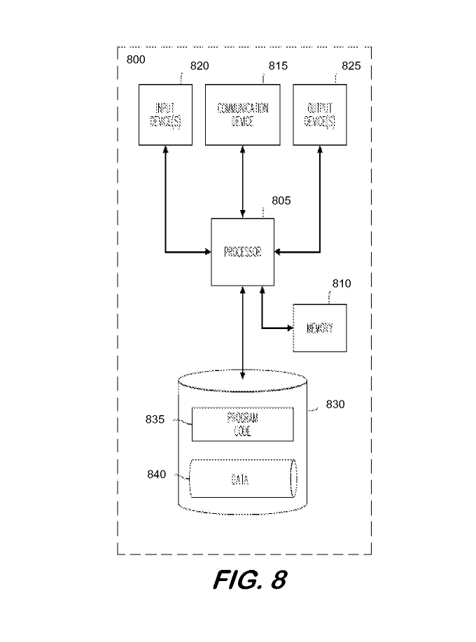

FIG. 8 is a block diagram overview of a system or apparatus 800 according to some embodiments. System 800 may be, for example, associated with any of the devices described herein, including for example a merchant system device and an application server supporting or providing a D-CVC validation service 535. System 800 comprises a processor 805, such as one or more commercially available Central Processing Units (CPUs) in the form of one-chip microprocessors or a multi-core processor, coupled to a communication device 815 configured to communicate via a communication network (not shown in FIG. 8) to another device or system. In the instance system 800 comprises a server (e.g., supporting the functions and services provided by a card verifier entity), communication device 815 may provide a means for system 800 to interface with a client device (e.g., a merchant system device). System 800 may also include a local memory 810, such as RAM memory modules. The system further includes an input device 820 (e.g., a touchscreen, mouse and/or keyboard to enter content) and an output device 825 (e.g., a touchscreen, a computer monitor to display, a LCD display).

Processor 805 communicates with a storage device 830. Storage device 830 may comprise any appropriate information storage device, including combinations of magnetic storage devices (e.g., a hard disk drive), optical storage devices, and/or semiconductor memory devices. In some embodiments, storage device may comprise a database system.

Storage device 830 stores program code 835 that may provide computer executable instructions for processing D-CVC related transaction including, in some aspects the generation of the D-CVC and in some other aspects the verification of a D-CVC received in an authorization request for a particular transaction involving a particular PAN, in accordance with processes herein. Processor 805 may perform the instructions of the program code 835 to thereby operate in accordance with any of the embodiments described herein. Program code 835 may be stored in a compressed, uncompiled and/or encrypted format. Program code 835 may furthermore include other program elements, such as an operating system, a database management system, and/or device drivers used by the processor 805 to interface with, for example, peripheral devices. Storage device 830 may also include data 845 such as database records or look-up tables. Data 845 may be used by system 800, in some aspects, in performing the processes herein, including the D-CVC generation and D-CVC verification.

All systems and processes discussed herein may be embodied in program code stored on one or more computer-readable media. Such media may include, for example, a floppy disk, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, the method comprising:
receiving an authorization request associated with a transaction, the authorization request including a payment account number and a card verification value;
determining the authorization request is to be processed as including a dynamic card verification value;
automatically bypassing, in response to the determination that the authorization request is to be processed as including a dynamic card verification value, at least one card verification process to be used in a processing of the authorization request; and
sending the authorization request to a card verifier to verify the card verification value matches a dynamic card verification value of record.

2. The method of claim 1, further comprising:
receiving an indication from the card verifier that the card verification value does not match the dynamic card verification value of record;
denying the authorization request; and
providing an output of at least an indication of the denied authorization request.

3. The method of claim 1, wherein the card verification value comprises a string of three numerals.

4. The method of claim 1, wherein the card verification value is generated by at least one of a payment card having a display to display the card verification value, an application executing on a mobile device, and a browser-enabled application.

5. The method of claim 1, wherein the determining that the authorization request is to be processed as including a dynamic card verification value is based on at least one of the payment account number and a banking identification number associated with the payment account number.

6. The method of claim 1, wherein the at least one card verification process automatically bypassed includes an address verification process.

7. A computer-implemented method, the method comprising:
receiving an authorization request associated with a transaction, the authorization request including a payment account number and a card verification value;
determining the authorization request is to be processed as including a dynamic card verification value;
verifying whether the card verification value matches a dynamic card verification value of record;
transmitting, in an instance the card verification value is verified as matching the dynamic card verification value of record, the authorization request to a payment network for authorization of the transaction;
receiving an authorization response in reply to the transmitted authorization request; and
providing an output of at least an indication of the authorization response to a merchant associated with the transaction.

8. The method of claim 7, wherein the transmitted authorization request includes an indication that the card verification value has been verified.

9. The method of claim 7, further comprising:
verifying that the card verification value does not match the dynamic card verification value of record;
denying the authorization request; and
providing an output of at least an indication of the denied authorization request to the merchant.

10. The method of claim 7, wherein the card verification value comprises a string of three numerals.

11. The method of claim 7, wherein the card verification value is generated by at least one of a payment card having a display to display the card verification value, an application executing on a mobile device, and a browser-enabled application.

12. The method of claim 7, further comprising receiving data from an issuer to be used in the verifying, the data including at least the dynamic card verification value of record.

13. An apparatus comprising:
a processor; and
a memory device in communication with the processor and storing program instructions thereon, the processor operative with the program instructions to:
receive an authorization request associated with a transaction, the authorization request including a payment account number and a card verification value;
determine the authorization request is to be processed as including a dynamic card verification value;
verify whether the card verification value matches a dynamic card verification value of record;
transmit, in an instance the card verification value is verified as matching the dynamic card verification value of record, the authorization request to a payment network for authorization of the transaction;
receive an authorization response in reply to the transmitted authorization request; and
provide an output of at least an indication of the authorization response to a merchant associated with the transaction.

14. The apparatus of claim 13, wherein the transmitted authorization request includes an indication that the card verification value has been verified.

15. The apparatus of claim 13, wherein the processor is further operative with the program instructions to:
verify that the card verification value does not match the dynamic card verification value of record;
deny the authorization request; and
provide an output of at least an indication of the denied authorization request to the merchant.

16. The apparatus claim 13, wherein the card verification value comprises a string of three numerals.

17. The apparatus of claim 13, wherein the card verification value is generated by at least one of a payment card having a display to display the card verification value, an application executing on a mobile device, and a browser-enabled application.

18. The apparatus of claim 13, wherein the processor is operative with the program instructions to further receive data from an issuer to be used in the verifying, the data including at least the dynamic card verification value of record.
